(19) United States
(12) Patent Application Publication
(10) Pub. No.: US 2026/0011711 A1
(43) Pub. Date: Jan. 8, 2026

(54) APPARATUS FOR MANUFACTURING ELECTRODE AND METHOD OF MANUFACTURING SAME

(71) Applicant: SK On Co., Ltd., Seoul (KR)

(72) Inventors: Sang Heon SONG, Daejeon (KR); Jin Ah SON, Daejeon (KR); Yoon Sung OH, Daejeon (KR)

(21) Appl. No.: 19/170,069

(22) Filed: Apr. 4, 2025

(30) Foreign Application Priority Data
Jul. 8, 2024 (KR) 10-2024-0089765

(51) Int. Cl. H01M 4/04

(52) U.S. Cl. CPC H01M 4/0435

(57) ABSTRACT

There is provided an apparatus for manufacturing an electrode including a coated portion on which an active material is applied to foil and a non-coated portion on which the active material is not applied to the foil. The apparatus includes an elongation roller portion configured for elongating the non-coated portion by pressing the non-coated portion, and a rolling roller portion configured for rolling the coated portion by pressing the coated portion. The elongation roller portion includes an upper elongation roller including a plurality of rollers for pressing the non-coated portion from above the non-coated portion, and a lower elongation roller including a plurality of rollers for pressing the non-coated portion from below the non-coated portion.

### CROSS-REFERENCE TO RELATED APPLICATION(S)

This patent document claims the priority and benefits of Korean Patent Application No. 10-2024-0089765 filed on Jul. 8, 2024, the disclosure of which is incorporated herein by reference in its entirety.

### TECHNICAL FIELD

The disclosure and implementations disclosed in this patent document generally relate to an apparatus and method for manufacturing an electrode having a non-coated portion and a coated portion, and more particularly, to an apparatus and method for manufacturing an electrode by rolling a coated electrode with a coated portion applied thereto.

### BACKGROUND

A secondary battery cell is an energy storage means which may be charged with electricity and of which electricity may be discharged. Secondary battery cells are widely used in various means that use electricity as a power source. For example, secondary battery cells are used in various fields ranging from small devices such as mobile phones, laptops, and tablets to vehicles and energy storage devices.

A secondary battery cell may include a case (for example, a can, a pouch, or the like) and an electrode assembly. The electrode assembly includes an electrode and a separator and may be accommodated inside the case.

The electrode may include a coated portion on which an active material is applied to foil and a non-coated portion on which an active material is not applied to the foil. The coated electrode (electrode substrate) on which an active material is applied to a portion of the foil may undergo a rolling process (or a pressing process) to improve the energy density per unit volume.

### SUMMARY

Through the rolling process, the density of the electrode mixture layer of the coated electrode (electrode substrate) may increase and the volume may decrease. In the process of rolling the electrode under high pressure, the electrode may be fractured due to the difference in the amount of elongation between the coated portion and the non-coated portion. For example, due to the difference in the thickness of the coated portion and the non-coated portion, a difference in the amount of pressure applied by the rolling roller may occur between the coated portion and the non-coated portion, and thus a difference in the amount of elongation may occur.

According to an aspect of the present disclosure, an apparatus for manufacturing an electrode and a method of manufacturing an electrode, in which fracturing of an electrode may be prevented or reduced, may be provided.

According to an aspect of the present disclosures, an apparatus for manufacturing an electrode and a method of manufacturing an electrode that may reduce the stress applied to a non-coated portion during an elongation process of the non-coated portion may be provided.

According to an aspect of the present disclosure, an apparatus for manufacturing an electrode and a method of manufacturing an electrode may be provided in which a fracture phenomenon of an electrode may be reduced while significantly reducing a decrease in strength of the electrode.

According to an aspect of the present disclosure, a battery cell including an electrode manufactured by an apparatus for manufacturing an electrode and/or a method of manufacturing an electrode may be widely applied in green technology fields such as electric vehicles, battery charging stations, and solar power generation and wind power generation using batteries. In addition, a battery cell including an electrode manufactured by an apparatus for manufacturing an electrode and/or a method of manufacturing an electrode in the present disclosure may be used in eco-friendly electric vehicles, hybrid vehicles, or the like to prevent climate change by suppressing air pollution and greenhouse gas emissions.

In some embodiments of the present disclosure, there is provided an apparatus for manufacturing an electrode including a coated portion on which an active material is applied to foil and a non-coated portion on which the active material is not applied to the foil. The apparatus for manufacturing an electrode includes an elongation roller portion configured for elongating the non-coated portion by pressing the non-coated portion; and a rolling roller portion configured for rolling the coated portion by pressing the coated portion. The elongation roller portion includes an upper elongation roller including a plurality of rollers for pressing the non-coated portion from above the non-coated portion, and a lower elongation roller including a plurality of rollers for pressing the non-coated portion from below the non-coated portion.

In one embodiment, the upper elongation roller and the lower elongation roller may each include two or more rollers.

In one embodiment, at least one of the upper elongation roller and/or the lower elongation roller may include three or more rollers.

In one embodiment, the rolling roller portion may be located at a rear end of the elongation roller portion in a direction of travel of the electrode.

In one embodiment, the elongation roller portion may be configured such that a depth of pressing the non-coated portion through the upper elongation roller and the lower elongation roller increases at a rear end than at a front end in a direction of travel of the electrode.

In one embodiment, a depth of pressing the non-coated portion by at least one of the upper elongation roller and/or the lower elongation roller may be configured to gradually increase from a front end to a rear end in a direction of travel of the electrode.

In one embodiment, the plurality of rollers of the upper elongation roller and the plurality of rollers of the lower elongation roller may be disposed to be staggered, so that central axes thereof do not face each other in a direction perpendicular to a direction of travel of

In one embodiment, at least some rollers of the plurality of rollers provided in the upper elongation roller and the lower elongation roller may include a surface treatment portion configured to increase a coefficient of friction between the at least some rollers and the non-coated portion when contacting with the non-coated portion, compared to a smooth or untreated roller surface.

In one embodiment, the surface treatment portion may include at least one of an uneven portion formed to have a predetermined pattern on surfaces of the at least some rollers or formed by uneven processing, and/or a surface coated portion in which a coating material is coated on the surfaces of the at least some rollers.

In one embodiment, the uneven portion may include a curved surface that is formed on the surface of the at least some rollers and has a constant pitch and height.

In one embodiment, the apparatus for manufacturing an electrode may further include a heating portion located at a front end of the elongation roller portion in a direction of travel of the electrode and heating the non-coated portion.

In some embodiments of the present disclosure, a method of manufacturing an electrode includes a process of preparing a coated electrode including a coated portion with an active material applied to foil and a non-coated portion without the active material applied to the foil; a process of elongating the non-coated portion by pressing the non-coated portion; and a process of rolling the coated portion by pressing the coated portion. The process of elongating the non-coated portion presses the non-coated portion, using an upper elongation roller including a plurality of rollers to press the non-coated portion from above the non-coated portion, and a lower elongation roller including a plurality of rollers to press the non-coated portion from below the non-coated portion.

In one embodiment, the upper elongation roller and the lower elongation roller may each include two or more rollers, and at least one of the upper elongation roller and/or the lower elongation roller may include three or more rollers.

In one embodiment, the process of rolling the coated portion may be performed subsequent to the process of elongating the non-coated portion.

In one embodiment, the process of elongating the non-coated portion may be configured such that a depth of pressing the non-coated portion by the upper elongation roller and the lower elongation roller increases at a rear end than at a front end in a direction of travel of the electrode.

In one embodiment, the process of elongating the non-coated portion may be performed in a state where no slip occurs between at least some rollers and the non-coated portion.

In one embodiment, the method of manufacturing an electrode may further include a heating process of heating the non-coated portion, and the heating process may be performed before the process of elongating the non-coated portion.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating an apparatus for manufacturing an electrode according to one embodiment.

FIG. 2 is a plan view of the apparatus for manufacturing an electrode illustrated in FIG. 1.

FIG. 3 is a cross-sectional view taken along line I-I′ of FIG. 2.

FIG. 4 is a cross-sectional view illustrating a modified embodiment of FIG. 3.

FIGS. 5A and 5B are cross-sectional views illustrating circumferential cross-sections of a roller, respectively.

FIG. 6 is a plan view illustrating an apparatus for manufacturing an electrode according to a modified embodiment.

FIG. 7 is a perspective view schematically illustrating an apparatus for manufacturing an electrode according to another embodiment.

FIG. 8 is a flow chart illustrating a method of manufacturing an electrode according to one embodiment.

### DETAILED DESCRIPTION

Features of the present disclosure disclosed in this patent document are described by example embodiments with reference to the accompanying drawings.

The same e reference numbers or symbols described in respective drawings attached to this specification represent parts or components that perform substantially the same functions. For the convenience of explanation and understanding, the same reference numbers or symbols may be used in different embodiments. In detail, even if components with the same reference numbers are depicted in multiple drawings, the multiple drawings do not all mean one embodiment.

In the following description, the singular expression includes the plural expression unless the context clearly indicates otherwise. It should be understood that the terms “include”, “comprise” and the like are intended to specify the presence of features, numbers, steps, operations, components, parts, or combinations thereof described in the specification, but do not preclude the possibility of the presence or addition of one or more other features, numbers, steps, operations, components, parts, or combinations thereof.

In addition, in the following description, the expressions “upper side”, “upper”, “upper portion”, “lower”, “below”, “side”, “side surface”, “front”, “rear”, and the like are expressed based on the direction depicted in the drawings, and it is noted in advance that they may be expressed differently if the direction of the corresponding object changes.

In addition, terms including ordinal numbers such as “first”, “second”, and the like may be used in the present specification and claims to distinguish between components. These ordinal numbers are used to distinguish between identical or similar components, and the meaning of the terms should not be limited due to the use of these ordinal numbers. For example, the components associated with these ordinal numbers should not be limited in their order of use or arrangement, and the like, by their numbers. If necessary, respective ordinal numbers may be used interchangeably.

Hereinafter, the present disclosure will be described in detail with reference to the attached drawings. However, this is merely illustrative and the present disclosure is not limited to the detailed embodiments described as examples.

With reference to FIGS. 1 to 4, an apparatus 100 for manufacturing an electrode according to one embodiment will be described.

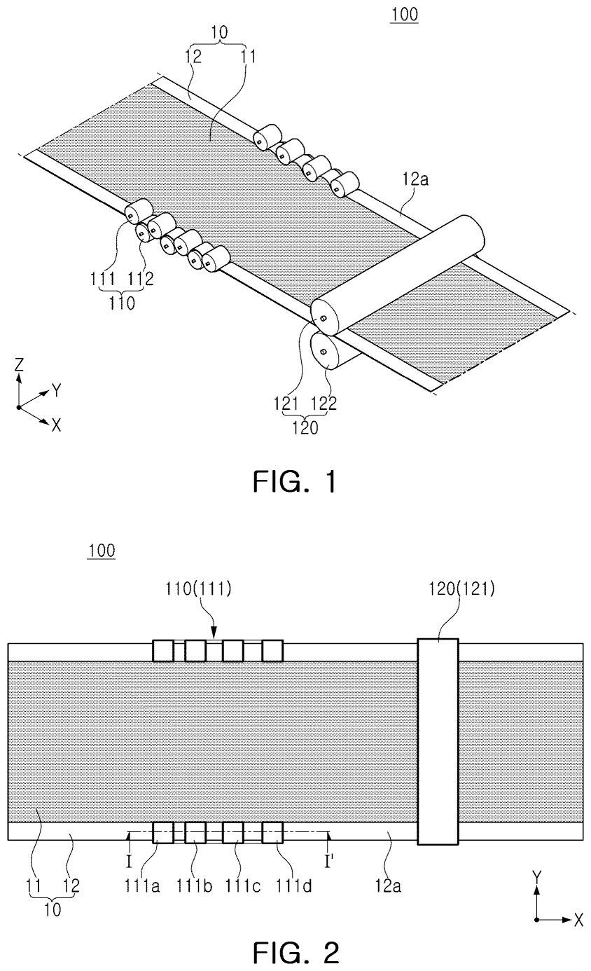

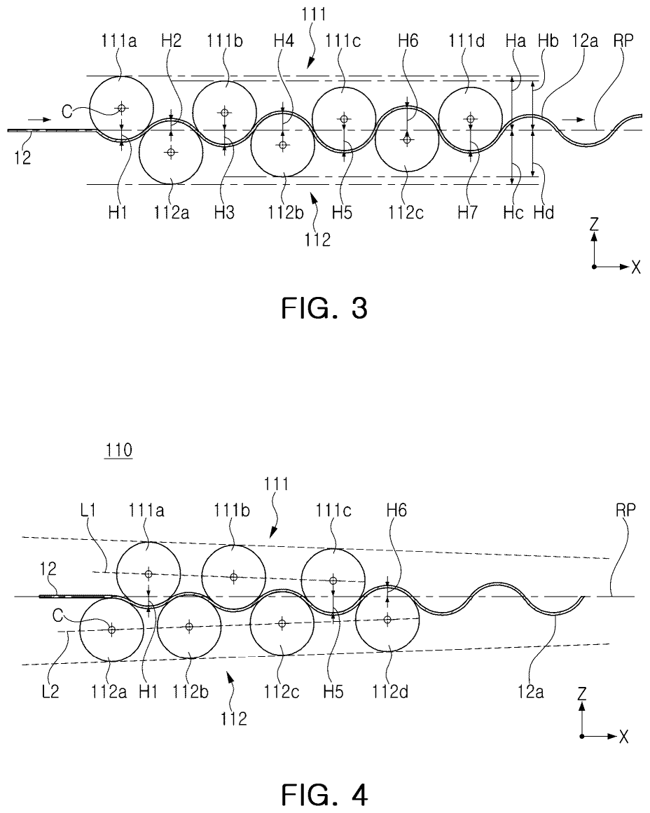

FIG. 1 is a perspective view schematically illustrating an apparatus 100 for manufacturing an electrode according to one embodiment, and FIG. 2 is a plan view of the apparatus 100 for manufacturing an electrode illustrated in FIG. 1. FIG. 3 is a cross-sectional view taken along line I-I′ of FIG. 2, and FIG. 4 is a cross-sectional view illustrating a modified embodiment of FIG. 3.

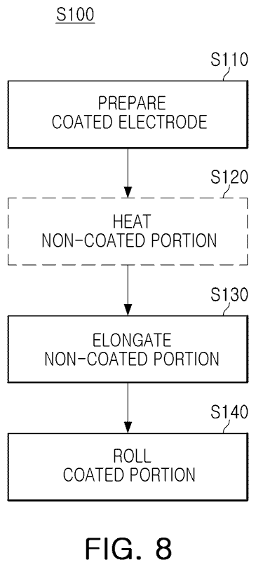

The electrode 10 may include a positive electrode and a negative electrode. The electrode 10 may be formed by applying slurry to foil (or current collector) formed of aluminum or copper. The slurry includes an active material, a conductive material, and a binder, and may be applied to both sides of the foil. The electrode 10 may include a coated portion 11 on which the slurry is applied, and a non-coated portion 12 on which the slurry is not applied. The coated portion is also referred to as a coated part, and the non-coated portion is also called a non-coated part. The apparatus 100 for manufacturing an electrode and the method of manufacturing an electrode (S100 of FIG. 8) of the present disclosure may be applied to the manufacturing of a positive electrode and a negative electrode.

Referring to FIGS. 1 to 4, an apparatus 100 for manufacturing an electrode according to one embodiment is an apparatus for manufacturing an electrode 10 including a coated portion 11 on which an active material is coated on foil and a non-coated portion 12 on which an active material is not coated. The apparatus 100 for manufacturing an electrode according to one embodiment may include an elongation roller portion 110 configured for elongating the non-coated portion 12 by pressing the non-coated portion 12, and a rolling roller portion 120 configured for rolling the coated portion 11 by pressing the coated portion 11. The elongation roller portion 110 may include an upper elongation roller 111 including a plurality of rollers to press the non-coated portion 12 from above the non-coated portion 12, and a lower elongation roller 112 including a plurality of rollers to press the non-coated portion 12 from below the non-coated portion 12.

The elongation roller portion 110 may press the non-coated portion 12 to elongate the non-coated portion 12. The elongation roller portion 110 may be disposed at the upper and lower portions of the electrode 10, respectively, to press the non-coated portion 12 from above and below the non-coated portion 12.

The elongation roller portion 110 may include an upper elongation roller 111 disposed above the non-coated portion 12 and a lower elongation roller 112 disposed below the non-coated portion 12. The upper elongation roller 111 includes a plurality of rollers disposed on the upper side of the non-coated portion 12 and may pressurize the non-coated portion 12 from the upper side of the non-coated portion 12. The lower elongation roller 112 includes a plurality of rollers disposed on the lower side of the non-coated portion 12 and may pressurize the non-coated portion 12 from the lower side of the non-coated portion 12. Accordingly, the non-coated portion 12 may be pressed and elongated between the upper elongation roller 111 and the lower elongation roller 112, each of which includes a plurality of rollers.

A plurality of rollers provided in the elongation roller portion 110 may cover the non-coated portion 12 in the width direction (Y) of the electrode 10. The plurality of rollers provided in the elongation roller portion 110 may be disposed at a position that does not cover the coated portion 11. However, the elongation roller portion 110 may also have a size that presses a portion of the coated portion 11 together with the non-coated portion 12.

The upper elongation roller 111 and the lower elongation roller 112 may each include two or more rollers. For example, as illustrated in FIGS. 1 to 3, the upper elongation roller 111 may include a first upper roller 111a, a second upper roller 111b, a third upper roller 111c, and a fourth upper roller 111d, and the lower elongation roller 112 may include a first lower roller 112a, a second lower roller 112b, and a third lower roller 112c. As another example, as illustrated in FIG. 4, an upper elongation roller 111 may include a first upper roller 111a, a second upper roller 111b, and a third upper roller 111c, and a lower elongation roller 112 may include a first lower roller 112a, a second lower roller 112b, a third lower roller 112c, and a fourth lower roller 112d.

However, the number of rollers included in the upper elongation roller 111 and the number of rollers included in the lower elongation roller 112 may be variously changed. For example, if the number of rollers included in the upper elongation roller 111 is two or more, the number of rollers included in the upper elongation roller 111 may be the same as the number of rollers included in the lower elongation roller 112, or may be more or less than the number of rollers included in the lower elongation roller 112. In the case of the lower elongation roller 112, if the number of rollers is two or more, the number of rollers included in the lower elongation roller 112 may be the same as the number of rollers included in the upper elongation roller 111, or may be more or less than the number of rollers included in the upper elongation roller 111.

At least one of the upper elongation roller 111 and/or the lower elongation roller 112 may include three or more rollers. For example, one of the upper elongation roller 111 and the lower elongation roller 112 may include two rollers, and the other may include three rollers. In addition, as illustrated in FIGS. 1 to 4, both the upper elongation roller 111 and the lower elongation roller 112 may include three or more rollers. The elongation roller portion 110 may include five or more rollers.

In this way, when both the upper elongation roller 111 and the lower elongation roller 112 include multiple rollers, the time of the process of performing the elongation may be lengthened.

In detail, in the case of the comparative example in which the elongation is performed with a relatively small number of rollers at a high moving speed of the electrode 10, a large amount of deformation should be applied instantaneously to the non-coated portion 12. On the other hand, according to an embodiment, since the elongation is performed through multiple rollers included in each of the upper elongation roller 111 and the lower elongation roller 112, the time of the process of performing the elongation is relatively longer than in the comparative example, and thus the deformation applied to the non-coated portion 12 may be distributed by the multiple rollers. For example, when the elongation roller portion 110 includes seven rollers, the total amount of elongation of the non-coated portion 12 may be distributed by the seven rollers. Therefore, according to an embodiment, during the elongation process of the non-coated portion 12, the fracture phenomenon occurring at the boundary area of the non-coated portion 12 or the non-coated portion 12 and the coated portion 11 may be reduced.

Referring to FIG. 3, the non-coated portion 12 may be pressed upward or downward with respect to the reference plane (RP) by a plurality of rollers. The reference plane (RP) may be defined as a plane passing through the center of the non-coated portion 12 before the non-coated portion 12 is pressed. The non-coated portion 12 may be elongated while sequentially passing through the first upper roller 111a, the first lower roller 112a, the second upper roller 111b, the second lower roller 112b, and the like. Finally, when passing through the fourth upper roller 111d, the non-coated portion in an elongated state 12a may be formed. The cross-section of the non-coated portion in an elongated state 12a may have a shape alternately bent in the upper and lower directions. For example, the cross-section of the non-coated portion in an elongated state 12a may have a shape similar to a sine curve or a cosine curve.

In the case of manufacturing an electrode 10 in which the non-coated portion 12 is disposed on both sides of the width direction (Y) of the coated portion 11, an elongation roller portion 110 may be disposed on each non-coated portion 12. Multiple rollers disposed on respective non-coated portions 12 (C) of the rollers may face each other, and the central axes facing each other may form a straight line.

The elongation roller portion 110 may be configured such that the depth of pressing the non-coated portion 12 increases at the rear end than at the front end in the direction of travel (X) of the electrode 10. For example, the depth at which the non-coated portion 12 is pressed at the front end in the direction of travel (X) of the electrode 10 may be made small, and the depth at which the non-coated portion 12 is pressed at the rear end in the direction of travel (X) of the electrode 10 may be made large. Accordingly, the total elongation of the non-coated portion 12 may be distributed by the rollers at the front and rear ends of the direction of travel (X) of the electrode 10, so that the stress applied to the non-coated portion 12 may be reduced.

The depth at which the non-coated portion 12 is pressed may be defined as the depth at which the non-coated portion 12 is pressed by respective rollers, based on the reference plane (RP). The depth at which the elongation roller portion 110 presses the non-coated portion 12 may be adjusted according to the distances between the central axes (C) of respective rollers and the reference plane (RP).

Referring to FIG. 3, the non-coated portion 12 may be oriented while sequentially passing through the first upper roller 111a, the first lower roller 112a, the second upper roller 111b, the second lower roller 112b, the third upper roller 111c, the third lower roller 112c, and the fourth upper roller 111d. In this case, the depth H6 at which the third lower roller 112c located at the rear end in the direction of travel (X) of the electrode 10 presses the non-coated portion 12 or the depth H7 at which the fourth upper roller 111d at the rear end in the direction of travel (X) of the electrode 10 presses the non-coated portion 12 may have a value greater than the depth H1 at which the first upper roller 111a located at the front end in the direction of travel (X) of the electrode 10 presses the non-coated portion 12 or the depth H2 at which the first lower roller 112a located at the front end in the direction of travel (X) of the electrode 10 presses the non-coated portion 12.

To increase the depth at which the non-coated portion 12 is pressed at the rear end rather than at the front end in the direction of travel (X) of the electrode 10, the distance between the central axis (C) of each roller and the reference plane (RP) or the maximum distance between the outer peripheral surface of each roller and the reference plane (RP) may be adjusted. When a plurality of rollers provided in the upper elongation roller 111 have the same diameter, a maximum height (Ha) between the outer peripheral surface of the first upper roller 111a located at the front end and the reference plane (RP) in the direction of travel (X) of the electrode 10 may have a value greater than the maximum height (Hb) between the outer peripheral surface of the second upper roller 111b located at the rear end and the reference plane (RP). Similarly, when a plurality of rollers provided in the lower elongation roller 112 have the same diameter, the maximum height (Hc) between the outer peripheral surface of the first lower roller 112a located at the front end and the reference plane (RP) in the direction of travel (X) of the electrode 10 may have a value greater than the maximum height (Hb) between the outer peripheral surface of the second lower roller 112b located at the rear end and the reference plane (RP).

The depth at which at least one of the upper elongation roller 111 and/or the lower elongation roller 112 presses the non-coated portion 12 may be configured to gradually increase from the front end to the rear end in the direction of travel (X) of the electrode 10.

For example, when the upper elongation roller 111 includes four rollers, the depth H1 at which the first upper roller 111a presses the non-coated portion 12, the depth H3 at which the second upper roller 111b presses the non-coated portion 12, the depth H7 at which the third upper roller 111c presses the non-coated portion 12, and the depth H7 at which the fourth upper roller 111d presses the non-coated portion 12 may be configured to gradually increase. As another example, when the lower elongation roller 112 includes three rollers, the depth H2 at which the first lower roller 112a presses the non-coated portion 12, the depth H4 at which the second lower roller 112b presses the non-coated portion 12, and the depth H6 at which the third lower roller 112c presses the non-coated portion 12 may be configured to gradually increase.

In addition, the depth at which the non-coated portion 12 is pressed by the plurality of rollers provided in the upper elongation roller 111 and the plurality of rollers provided in the lower elongation roller 112 may be configured to gradually increase from the front end to the rear end in the direction of travel (X) of the electrode 10. For example, the depth H1 at which the first upper roller 111a presses the non-coated portion 12, the depth H2 at which the first lower roller 112a presses the non-coated portion 12, the depth H3 at which the second upper roller 111b presses the non-coated portion 12, and the like may be gradually increased.

The amount of deformation at which the non-coated portion 12 is elongated by the elongation roller portion 110 or the maximum depth at which the non-coated portion 12 is pressed may be adjusted according to the amount of deformation at which the coated portion 11 is elongated when the coated portion 11 is pressed by the rolling roller portion 120. The amount of deformation at which the non-coated portion 12 is elongated by the elongation roller portion 110 may be set to have the same or similar value as the amount of deformation at which the coated portion 11 is elongated by the rolling roller portion 120. A maximum depth to which the non-coated portion 12 is pressed may have a value of more than 0 mm, 0.5 mm or more, 1 mm or more, 2 mm or more, 3 mm or more, or 5 mm or more. The maximum depth to which the non-coated portion 12 is pressed may have a value of 200 mm or less, 100 mm or less, 50 mm or less, 30 mm or less, 20 mm or less, or 10 mm or less. The maximum depth to which the non-coated portion 12 is pressed may be set within a limit at which the non-coated portion 12 may be elongated without being broken.

The plurality of rollers provided in the upper elongation roller 111 and the plurality of rollers provided in the lower elongation roller 112 may be disposed to be staggered so that respective central axes (C) thereof do not face each other in a direction perpendicular to the direction of travel (X) of the electrode 10. For example, virtual lines respectively connecting the central axes (C) of the rollers provided adjacent to each other in the upper elongation roller 111 and the lower elongation roller 112 may have a zigzag shape with respect to the reference plane (RP). For example, a line connecting the central axis (C) of the first upper roller 111a and the central axis (C) of the first lower roller 112a, a line connecting the central axis (C) of the first lower roller 112a and the central axis (C) of the second upper roller 111b, and a line connecting the central axis (C) of the second upper roller 111b and the central axis (C) of the second lower roller 112b may be inclined to cross the reference plane (RP). The non-coated portion 12 may be sequentially elongated while passing through a plurality of rollers that are disposed to be staggered so as not to face each other.

It is also possible for the plurality of rollers provided in the elongation roller portion 110 to be configured to have a certain pattern of arrangement. Referring to FIG. 4, the elongation roller portion 110 may be configured such that at least one of a line L1 connecting the central axes (C) of the plurality of rollers provided in the upper elongation roller 111 and/or a line L2 connecting the central axes (C) of the plurality of rollers provided in the lower elongation roller 112 is a straight line. For example, the line L1 connecting the central axes (C) of the first upper roller 111a, the second upper roller 111b, and the third upper roller 111c may be a straight line.

However, the arrangement structure of the plurality of rollers provided in the elongation roller portion 110 may be variously changed. For example, the number of rollers provided in the upper elongation roller 111, the number of rollers provided in the lower elongation roller 112, and the depth at which respective rollers press the non-coated portion 12 may be changed according to the specifications required for the elongation process.

The rolling roller portion 120 may pressurize the coated portion 11 to roll the coated portion 11. The rolling roller portion 120 may include at least one pair of rollers pressurize the coated portion 11 from the upper and lower sides of the electrode 10. For example, the rolling roller portion 120 may include an upper rolling roller 121 and a lower rolling roller 122 that pressurize the coated portion 11 from the upper and lower sides of the electrode 10. The rolling roller portion 120 may roll the electrode 10 over the entire width of the electrode 10. For example, the upper rolling roller 121 and the lower rolling roller 122 may have a width that covers both the coated portion 11 and the non-coated portion 12, respectively, so that the axial lengths (corresponding to the width direction of the electrode) of the upper rolling roller 121 and the lower rolling roller 122 may have a value greater than the width of the electrode 10. The amount of pressure applied to the rolling roller portion 120 may be determined by considering the thickness reduction amount of the active material (or slurry) applied to the foil, the thickness of the coated portion 11 in the rolled state, or the like.

The rolling roller portion 120 may be located at the rear end of the elongation roller portion 110 in the direction of travel (X) of the electrode 10.

For example, the rolling roller portion 120 may roll the coated portion 11 in a state where the non-coated portion 12 is elongated by the elongation roller portion 110. In the rolling process by the rolling roller portion 120, a difference in the amount of pressure applied between the coated portion 11 and the non-coated portion 12 may occur due to the difference in the thickness of the coated portion 11 and the non-coated portion 12. For example, since the coated portion 11 has a relatively thicker thickness than the non-coated portion 12, the amount of elongation of the coated portion 11 may have a relatively larger value than that of the non-coated portion 12. According to an embodiment, since the coated portion 11 is elongated by the rolling roller portion 120 in a state where the non-coated portion 12 is elongated by the elongation roller portion 110, the difference in the amount of elongation between the coated portion 11 and the non-coated portion 12 may be reduced. Accordingly, it is possible to prevent or reduce breakage of the electrode 10 in the process of performing rolling by the rolling roller portion 120 and/or the subsequent process.

Since the rolling roller portion 120 presses the coated portion 11 and the non-coated portion 12 together, not only may the coated portion 11 be elongated, but also the non-coated portion in an elongated state 12a may be spread out. Accordingly, the non-coated portion 12 of the electrode 10 that has passed through the rolling roller portion 120 may be in a flat state without wrinkles.

Meanwhile, in the case of the embodiments illustrated in FIGS. 1 to 4, the time of the elongation process may be extended through the multiple rollers provided in the elongation roller portion 110, and the total amount of elongation of the non-coated portion 12 may be distributed to the multiple rollers, and thus it is possible to omit the heating process. In this case, since the material strength of the non-coated portion 12 may be prevented from being reduced, the occurrence of defects in the subsequent process (for example, the welding process of the electrode tab) may be reduced. According to an embodiment, the phenomenon of fracture of the electrode 10 may be reduced without lowering the strength of the electrode 10 in the elongation process of the non-coated portion 12. However, the present disclosure does not exclude a heating process, and it is also possible to include a heating portion 130 of FIG. 7 as in the embodiment illustrated in FIG. 7.

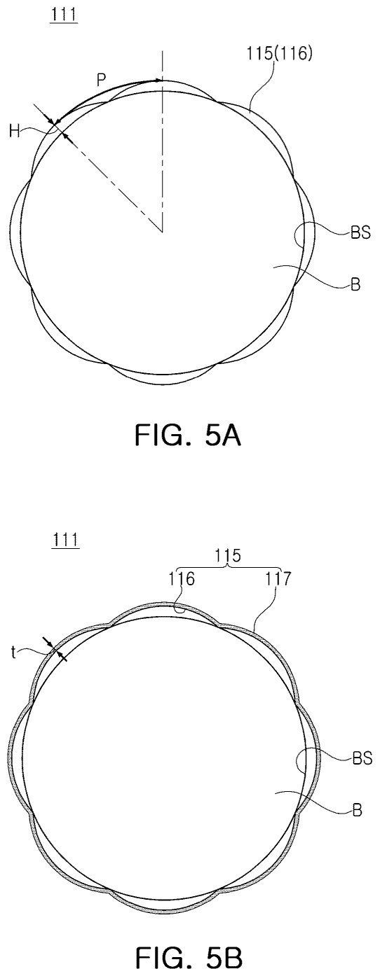

FIG. 5A and FIG. 5B are cross-sectional views illustrating circumferential cross-sections of the rollers, respectively.

Referring to FIG. 5A and FIG. 5B, at least some of the rollers provided in the upper elongation roller 111 and the lower elongation roller 112 may include a surface treatment portion 115 configured to increase the coefficient of friction between the at least some rollers and the non-coated portion when contacting with the non-coated portion 12, compared to a smooth or untreated roller surface.

The surface treatment portion 115 will be described by taking one of the upper elongation rollers 111 as an example.

The roller may include a cylindrical body (B) and a surface treatment portion 115 formed on an outer peripheral surface (BS) of the body (B). When the outer peripheral surface (BS) of the body (B) has a smooth surface, the surface friction coefficient has a small value. In this case, when the non-coated portion 12 is pressed through the roller, slip occurs between the outer peripheral surface (BS) of the roller and the non-coated portion 12, and thus the non-coated portion 12 may be damaged.

The surface treatment portion 115 may be disposed on at least one of the plurality of rollers provided in each of the upper elongation roller 111 and the lower elongation roller 112. If slip between the elongation roller portion 110 and the non-coated portion 12 may be prevented, the surface treatment portion 115 may be provided only on some of the plurality of rollers. For example, the surface treatment portion 115 may be provided on at least one roller of the upper elongation roller 111 and not provided on the lower elongation roller 112.

According to an embodiment, the surface treatment portion 115 may include an integral configuration formed on the outer peripheral surface (BS) of the body (B) so that the coefficient of friction increases when in contact with the non-coated portion 12. For example, the surface treatment portion 115 may include at least one of an uneven portion 116 formed to have a predetermined pattern on at least a portion of the surface of the roller or formed by rough processing, and/or a surface coated portion 117 in which a coating material is coated on at least a portion of the surface of the roller.

Referring to FIG. 5A, the surface treatment portion 115 may include an uneven portion 116. The uneven portion 116 may be formed to have a predetermined pattern on the surface of the roller. For example, as illustrated in FIG. 5A, the uneven portion 116 may include curved surfaces that is formed on the surface of the at least some rollers and has a constant/predetermined pitch and height. The curved surface having a predetermined pitch (P) and height (H) may have a shape extending along the axial direction of the roller (corresponding to the width direction of the electrode). Since the uneven portion 116 of the curved surface forms hills and valleys, friction increases when coming into contact with the non-coated portion 12, and slipping may be prevented.

For example, the height (H) of the uneven portion 116 may be 5 mm or less, 4 mm or less, 3 mm or less, 2 mm or less, or 1 mm or less. The height (H) of the uneven portion 116 of the curved surface may have a value of 0.01 mm or more. The outer peripheral surface (BS) of the roller body (B) may have a circular cross-section, and the height of the uneven portion 116 may be defined as a height protruding in the radial direction from the outer peripheral surface (BS) of the roller body (B). The pitch (P) of the uneven portion 116 may be defined as a distance between hills. In the present disclosure, the pitch (P) may be defined as a circular arc length in the circumferential direction from a vertex of the uneven portion 116. The pitch (P) may have a value of 20 mm or less, 15 mm or less, 10 mm or less, or 5 mm or less. The pitch (P) may have a value of 0.5 mm or more, or 1 mm or more. However, the height (H) and pitch (P) of the uneven portion 116 are not limited to the aforementioned values, and various changes are possible as long as slippage may be prevented.

The uneven portion 116 is not limited to a curved surface, and the shape and structure of the uneven portion 116 may be variously changed. In addition, the uneven portion 116 may also be formed by processing to form a grid-like micro-roughness on the surface of the roller, processing to increase surface roughness, or the like.

Referring to FIG. 5B, the surface treatment portion 115 may include an uneven portion 116 and a surface coated portion 117. The surface coated portion 117 may be formed by coating a coating material on the surface of the roller. The surface coated portion 117 may be formed of various coating materials as long as the coefficient of friction may be increased compared to a smooth roller surface. As an example, the coating material may include a material such as silicone or rubber. The surface coated portion 117 may be formed on the surface of the uneven portion 116 as illustrated in FIG. 5B, but is not limited thereto. For example, the surface coated portion 117 may also be formed directly on the outer peripheral surface (BS) of the roller body (B). The thickness (t) of the surface coated portion 117 may be set according to the material of the surface coated portion 117 or the method of forming the surface coated portion 117 on the roller.

In this way, when forming a surface treatment portion 115 on the surface of the roller to increase the coefficient of friction, the slip phenomenon between the elongation roller portion 110 and the non-coated portion 12 may be prevented or reduced. Accordingly, damage to the non-coated portion 12 due to slip during the elongation process of the non-coated portion 12 may be prevented.

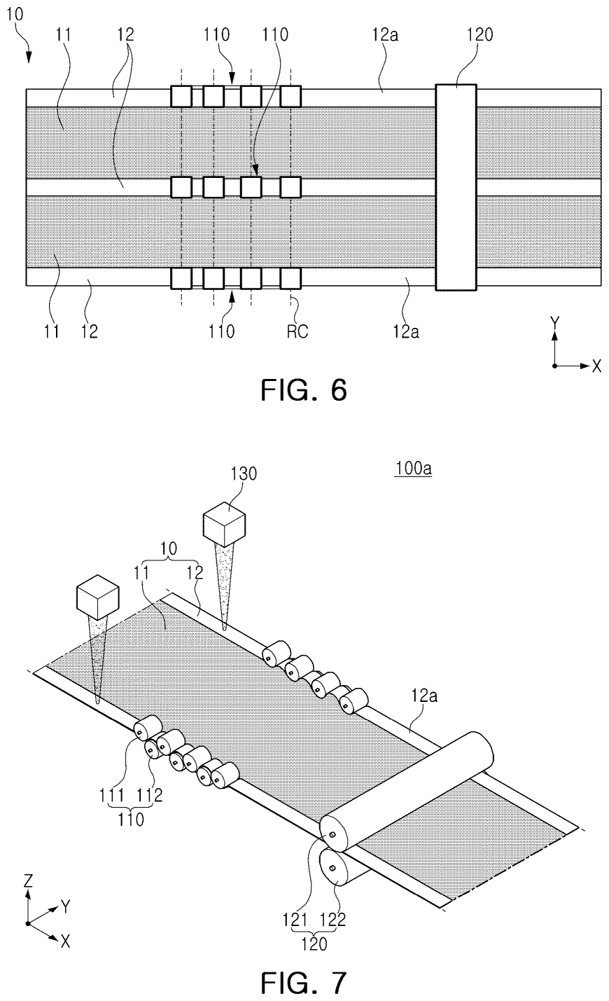

FIG. 6 is a plan view illustrating an apparatus 100 for manufacturing an electrode according to a modified embodiment.

Referring to FIG. 6, the electrode 10 may include a plurality of coated portions 11 and a plurality of non-coated portions 12. When a plurality of non-coated portions 12 are disposed on the electrode 10, the elongation roller portion 110 may be installed on each non-coated portion 12. The plurality of rollers disposed on respective non-coated portions 12 may face each other, and the rollers facing each other may share a rotation axis (RC). In this case, the installation of a driving mechanism for rollers for elongating a plurality of non-coated portions 12 may be easy. For example, a plurality of rollers may be driven simultaneously by a single driving mechanism such as a single motor.

When a plurality of coated portions 11 are disposed on an electrode 10, the rolling roller portion 120 may roll the electrode 10 over the entire width of the electrode 10. For example, the rolling roller portion 120 may have a width that covers both the plurality of coated portions 11 and the plurality of non-coated portions 12, so that the axial length of the rolling roller portion 120 may have a value greater than the width of the electrode 10.

FIG. 7 is a perspective view schematically illustrating an apparatus 100a for manufacturing an electrode according to another embodiment.

The apparatus 100a for manufacturing an electrode illustrated in FIG. 7 may additionally include a heating portion 130 positioned in front of the elongation roller portion 110 in the direction of travel (X) of the electrode 10 to heat the non-coated portion 12. In the apparatus 100 for manufacturing an electrode of the present disclosure, the heating portion 130 is not an essential component, but may be additionally included in the apparatus 100 for manufacturing an electrode.

The heating portion 130 may perform heat treatment to reduce the yield strength of the electrode material (for example, foil) to improve the formability of the non-coated portion 12. For example, the heating portion 130 may function to induce easy deformation in the elongation process of the non-coated portion 12. For example, the heating portion 130 may include a device that irradiates a laser. The heating portion 130 may irradiate a laser to the non-coated portion 12 to increase the temperature of the non-coated portion 12. The intensity and area of the laser irradiated to the non-coated portion 12 may be determined according to the manufacturing specifications of the electrode 10. However, the heating portion 130 is not limited to the above-described configuration. For example, the heating portion 130 may use an induction heating device, and various other changes are possible.

FIG. 8 is a flow chart illustrating a method of manufacturing an electrode (S100) according to one embodiment.

Referring to FIG. 8 together with FIGS. 1 to 7, a method of manufacturing an electrode (S100) according to one embodiment may include a process (S110) of preparing a coated electrode 10 including a coated portion 11 on which an active material is applied to foil and a non-coated portion 12 on which an active material is not applied to the foil, a process (S130) of elongating the non-coated portion 12 by pressing the non-coated portion 12, and a process (S140) of rolling the coated portion 11 by pressing the coated portion 11. The process (S130) of elongating the non-coated portion 12 may be performed by using an upper elongation roller 111 including a plurality of rollers to pressurize the non-coated portion 12 from the upper side of the non-coated portion 12 and a lower elongation roller 112 including a plurality of rollers to pressurize the non-coated portion 12 from the lower side of the non-coated portion 12.

The process (S110) of preparing the coated electrode 10 is a process of preparing an electrode substrate in a dried state after slurry is applied to foil (or current collector). In the present disclosure, the coated electrode 10 may be defined as an electrode substrate before the process (S130) of elongating the non-coated portion 12 and the process (S140) of rolling the coated portion 11 are performed. The electrode 10 manufactured by the present disclosure may be defined as an electrode 10 in a rolled state through a process (S140) of rolling the coated portion 11. The process (S110) of preparing the coated electrode 10 is a process of preparing an electrode substrate including a coated portion 11 on which an active material is applied to foil and a non-coated portion 12 on which an active material is not applied the foil.

The process (S130) of elongating the non-coated portion 12 may be performed through the elongation roller portion 110. Therefore, the description of the elongation roller portion 110 may also be applied to the process (S130) of elongating the non-coated portion 12.

The upper elongation roller 111 and the lower elongation roller 112 each include two or more rollers, and at least one of the upper elongation roller 111 and/or the lower elongation roller 112 may include three or more rollers. For example, one of the upper elongation roller 111 and the lower elongation roller 112 may include two rollers, and the other may include three rollers. In addition, as illustrated in FIGS. 1 to 4, both the upper elongation roller 111 and the lower elongation roller 112 may include three or more rollers. The elongation roller portion 110 may include five or more rollers. When both the upper elongation roller 111 and the lower elongation roller 112 include a plurality of rollers, the time for the process of performing the elongation may be lengthened, and the amount of strain applied to the non-coated portion 12 may be distributed by the plurality of rollers.

The process (S130) of elongating the non-coated portion 12 may be configured so that the depth at which the non-coated portion 12 is pressed by the upper elongation roller 111 and the lower elongation roller 112 increases at the rear end rather than at the front end in the direction of travel (X) of the electrode 10. For example, the depth at which the non-coated portion 12 is pressed at the front end in the direction of travel (X) of the electrode 10 may be made small, and the depth at which the non-coated portion 12 is pressed at the rear end in the direction of travel (X) of the electrode 10 may be made large. Accordingly, the total elongation amount of the non-coated portion 12 may be distributed by the rollers at the front end and the rear end in the direction of travel (X) of the electrode 10, so that the stress applied to the non-coated portion 12 may be reduced.

The process (S130) of elongating the non-coated portion 12 may be performed in a state where slip does not occur between at least some of the rollers and the non-coated portion 12. To this end, a surface treatment portion 115 may be provided on the surface of at least some of the rollers so that the coefficient of friction increases when in contact with the non-coated portion 12. The surface treatment portion 115 may include at least one of an uneven portion 116 formed to have a predetermined pattern on the surface of at least some of the rollers or formed by rough processing, and/or a surface coated portion 117 in which a coating material is coated on the surface of at least some of the rollers.

The process (S140) of rolling the coated portion 11 may be performed through the rolling roller portion 120. Therefore, the description of the rolling roller portion 120 may also be applied to the process (S140) of rolling the coated portion 11. The process (S140) of rolling the coated portion 11 may be performed subsequent to the process (S130) of elongating the non-coated portion 12. In the process (S140) of rolling the coated portion 11, the rolling roller portion 120 presses the coated portion 11 and the non-coated portion 12 together, so that not only the coated portion 11 is elongated, but also the non-coated portion in an elongated state 12a may be straightened. Accordingly, the non-coated portion 12 of the electrode 10 that has passed through the rolling roller portion 120 may attain a flat state without wrinkles.

In addition, the method of manufacturing an electrode (S100) according to one embodiment may additionally include a heating process (S120) of heating the non-coated portion 12. The heating process (S120) may be performed before the process (S130) of elongating the non-coated portion 12. In the present disclosure, the heating process (S120) is not an essential component and may be performed additionally. The heating process (S120) may perform heat treatment to reduce the yield strength of the electrode material, thereby improving the formability of the non-coated portion 12. The heating process (S120) may be performed by the heating portion 130, and the description of the heating portion 130 may also be applied to the heating process (S120).

As set forth above, according to one embodiment of the present disclosure, fracture of an electrode may be prevented or reduced.

According to one embodiment of the present disclosure, stress applied to a non-coated portion during an elongation process of the non-coated portion may be reduced.

According to one embodiment of the present disclosure, a fracture phenomenon of an electrode may be reduced while significantly reducing a decrease in strength of the electrode.

Only specific examples of implementations of certain embodiments are described. Variations, improvements and enhancements of the disclosed embodiments and other embodiments may be made based on the disclosure of this patent document.

What is claimed is:

1. An apparatus for manufacturing an electrode including a coated portion on which an active material is applied to foil and a non-coated portion on which the active material is not applied to the foil, the apparatus comprising:
an elongation roller portion configured for elongating the non-coated portion by pressing the non-coated portion; and
a rolling roller portion configured for rolling the coated portion by pressing the coated portion,
wherein the elongation roller portion includes an upper elongation roller including a plurality of rollers for pressing the non-coated portion from above the non-coated portion, and a lower elongation roller including a plurality of rollers for pressing the non-coated portion from below the non-coated portion.

2. The apparatus of claim 1, wherein the upper elongation roller and the lower elongation roller each include two or more rollers.

3. The apparatus of claim 2, wherein at least one of the upper elongation roller or the lower elongation roller includes three or more rollers.

4. The apparatus of claim 1, wherein the rolling roller portion is located at a rear end of the elongation roller portion in a direction of travel of the electrode.

5. The apparatus of claim 1, wherein the elongation roller portion is configured such that a depth of pressing the non-coated portion through the upper elongation roller and the lower elongation roller increases at a rear end than at a front end in a direction of travel of the electrode.

6. The apparatus of claim 1, wherein a depth of pressing the non-coated portion by at least one of the upper elongation roller or the lower elongation roller is configured to gradually increase from a front end to a rear end in a direction of travel of the electrode.

7. The apparatus of claim 1, wherein the plurality of rollers of the upper elongation roller and the plurality of rollers of the lower elongation roller are disposed to be staggered, so that central axes thereof do not face each other in a direction perpendicular to a direction of travel of the electrode.

8. The apparatus of claim 1, wherein at least some rollers of the plurality of rollers provided in the upper elongation roller and the lower elongation roller include a surface treatment portion configured to increase a coefficient of friction between the at least some rollers and the non-coated portion when contacting with the non-coated portion, compared to a smooth or untreated roller surface.

9. The apparatus of claim 8, wherein the surface treatment portion includes at least one of an uneven portion formed to have a predetermined pattern on surfaces of the at least some rollers or formed by uneven processing, or a surface coated portion in which a coating material is coated on the surfaces of the at least some rollers.

10. The apparatus of claim 9, wherein the uneven portion includes a curved surface that is formed on the surface of the at least some rollers and has a constant pitch and height.

11. The apparatus of claim 1, further comprising a heating portion located at a front end of the elongation roller portion in a direction of travel of the electrode and heating the non-coated portion.

12. A method of manufacturing an electrode, comprising:
a process of preparing a coated electrode including a coated portion with an active material applied to foil and a non-coated portion without the active material applied to the foil;
a process of elongating the non-coated portion by pressing the non-coated portion; and
a process of rolling the coated portion by pressing the coated portion,
wherein the process of elongating the non-coated portion presses the non-coated portion, using an upper elongation roller including a plurality of rollers to press the non-coated portion from above the non-coated portion, and a lower elongation roller including a plurality of rollers to press the non-coated portion from below the non-coated portion.

13. The method of claim 12, wherein the upper elongation roller and the lower elongation roller each include two or more rollers, and
at least one of the upper elongation roller or the lower elongation roller includes three or more rollers.

14. The method of claim 12, wherein the process of rolling the coated portion is performed subsequent to the process of elongating the non-coated portion.

15. The method of claim 12, wherein the process of elongating the non-coated portion is configured such that a depth of pressing the non-coated portion by the upper elongation roller and the lower elongation roller increases at a rear end than at a front end in a direction of travel of the electrode.

16. The method of claim 12, wherein the process of elongating the non-coated portion is performed in a state where no slip occurs between at least some rollers and the non-coated portion.

17. The method of claim 12, further comprising a heating process of heating the non-coated portion,
wherein the heating process is performed before the process of elongating the non-coated portion.
